(19) United States
(12) Patent Application Publication
(10) Pub. No.: US 2006/0247127 A1
(43) Pub. Date: Nov. 2, 2006

(54) Process for converting a carbonaceous source into an adsorption material

(76) Inventor: Aslam Mohamed Ali, Cupertino, CA (US)

Correspondence Address: GREENBERG TRAURIG, LLP, ONE INTERNATIONAL PLACE, 20th FL, ATTN: PATENT ADMINISTRATOR, BOSTON, MA, 02110, US

(21) Appl. No.: 11/395,100

(22) Filed: Mar. 31, 2006

Related U.S. Application Data
(60) Provisional application No. 60/667,294, filed on Apr. 1, 2005.

(51) Int. Cl. C01B 31/08

(52) U.S. Cl. 502/416

(57) ABSTRACT

A process for generating a nanoporous adsorption material is provided. The process involves heating a carbonaceous source in a controlled atmosphere to a temperature sufficient to achieve an exothermic reaction. The exothermic reaction generates hydrocarbon gases, and a substantially solid porous char mass. The hydrocarbon gases can be re-circulated into the controlled atmosphere with a mixture of steam and air to substantially increase the temperature therein. In the presence of increased temperature, nanoscaled size pores may be imparted to the porous char mass, and with continued exposure to the increased temperature, the porous char may be converted into a nanoporous adsorption material.

### RELATED U.S. APPLICATIONS

The present application claims priority to U.S. Provisional Application Ser. No. 60/667,294, filed Apr. 1, 2005, and U.S. patent application Ser. No. 11/299,038, filed Dec. 9, 2005, both of which are hereby incorporated herein by reference.

### TECHNICAL FIELD

The present invention relates to a process for manufacturing of adsorption materials, and more specifically, to a process for converting carbonaceous materials, such as used rubber tires, into adsorption materials.

### BACKGROUND ART

As the supply of available landfill space decreases, environmentally sensitive disposal of consumed vehicle tires has become an ever-increasing problem. In the U.S. alone, over 280 million vehicle tires are scrapped and shipped to landfills each year. Although some of the used vehicle tires are recycled to be used in pavement and others are burned as boiler fuel, more than 80% of used vehicle tires end up being deposited in landfills. Discarding spent vehicle tires in landfills has been recognized as a significant waste of recyclable resources. For many years it has been known that used vehicle tires can be recycled by pyrolysis to obtain valuable by-products that can be sold and reused.

Pyrolysis relies on the addition of heat to break chemical bonds, providing a mechanism by which organic compounds decompose and vaporize. Most systems for pyrolysis of waste rubber and other hydrocarbons report operating temperatures in the range of about 480° F. to 1740° F. At temperatures above approximately 480° F., tires release increasing amounts of liquid oil products and gases. Above 750° F., depending on the process employed, the yield of oil and solid products, such as char, may decrease relative to gas production. Tires contain over 80% carbon and hydrogen, and these elements form the principle constituents of the solid, liquid and gaseous pyrolysis products.

Pyrolysis, generally speaking, is a thermal distillation or decomposition of a substance. The pyrolytic conversion of used tires, such as that disclosed above, to obtain char, liquid and gaseous decomposition products is well known in the art. Such processes can promise a useful and environmentally friendly solution to the disposal of a significant portion of the used tires each year. Pyrolytic char particles usually display a wide range of particle and pore sizes. The principal difficulty experienced in processing such char is producing commercially acceptable products with a material ranging in a particle or pore size useful in an adsorption of liquid or gas.

The solid product produced by most pyrolysis processes that use tires or other solid organic feed stocks is termed “tire derived char”, “tire derived carbon char”, or carbon black. This solid product can be further processed and cleaned to produce a higher grade of carbon black. Carbon blacks differ in particle size, pore size, surface area, average aggregate mass, particle and mass aggregate distributions, structure and chemical composition, and are rated according to industry standards, based on these properties.

Many processes are known for recovering valuable by-products, such as hydrocarbon content (i.e. rubber materials), and carbon black content from used rubber tires for reuse, in one form or another. Some typical patents disclosing such processes include:

U.S. Pat. No. 3,997,407 to Fuji et al. discloses dry distillation of scrap tires in a vertical dry distillation retort to recover carbon black and oil.

U.S. Pat. No. 4,250,158 to Solbakken et al. discloses pyrolizing used tires in an oxygen-limited hydrocarbon vapor at sub atmospheric pressure to eventually recover carbon black, tar, oil and fuel gas.

Attempts to obtain a commercially acceptable carbon product are well documented in the prior art. One such approach is described in U.S. Pat. No. 3,644,131 to Gotshall. In particular, a carbon product equivalent in quality to high-grade carbon blacks can be obtained by retorting scrap tires and then comminuting the resulting char using a fluid energy mill to obtain a product having an average particle size of less than about 2.5 microns. The fluid energy mill employed may operate on steam at a temperature of about 450° F. The mill was arranged with opposing nozzles to cause the carbon particles carried in a first stream to impinge at sonic velocity upon carbon particles carried in a second stream causing autogenous grinding of the colliding particles. The finely divided carbon product was then coated with a portion of the heavy oils from the retort to obtain a stable product.

The problems experienced with existing approaches to the pyrolytic processing of scrap tires has served to limit their usefulness and success. The large capital costs and high operating expenses of present methods make those approaches commercially impractical. In addition, the conversion of used rubber tires into a carbon or char that has sufficient pore size has also been limited.

It is apparent that a process which alleviates and overcomes the deficiencies inherent in present practices would be a significant advance in the art.

### SUMMARY OF THE INVENTION

The present invention involves a process for generating an adsorption material. During the process, a carbonaceous source, such as used rubber tires, may be provided in a controlled atmosphere maintained at atmospheric pressure. In the controlled atmosphere, the carbonaceous source may be heated to a temperature sufficient to achieve an exothermic reaction, so as to generate hydrocarbon gases and a substantially solid porous char mass having a relatively high carbon content of at least 80%. The hydrocarbon gases, in an embodiment, may be used as a source of energy and can be re-circulated into the controlled atmosphere with a mixture of steam and air to substantially increase the temperature therein. In addition to increasing the temperature, the presence of hydrocarbon gases can enlarge the existing pores within the porous char mass to change the size of the pores. In the presence of increased temperature, the porous char mass may be converted into a porous adsorption material. The porous adsorption material may include pores that are nanoscale, microscale, mesoscale, or macroscale in size or a combination thereof.

### BRIEF DESCRIPTION OF DRAWINGS

FIG. 1 illustrates a system for use in production of adsorption materials from used tires, in accordance with one embodiment of the present invention.

### DESCRIPTION OF SPECIFIC EMBODIMENTS OF THE INVENTION

The present invention provides, in one embodiment, a method for generating an adsorption material for subsequent use as a fluid filtration mechanism. The method, as provided herein, utilizes a process for converting a carbonaceous material, for example, a rubber material, such as used rubber tires, into an adsorption material.

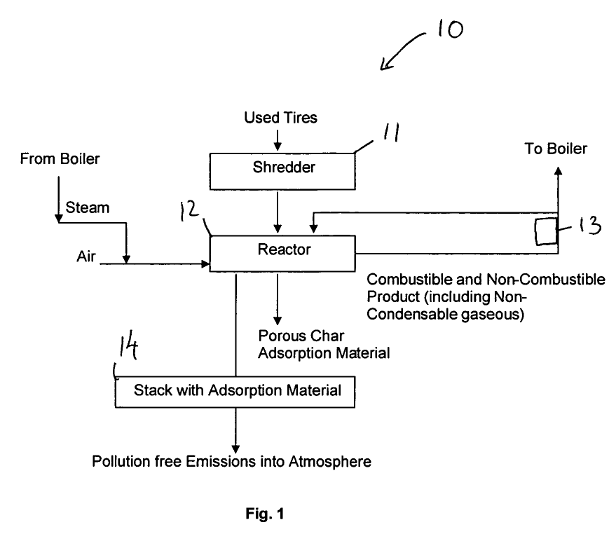

As illustrated in FIG. 1, the present invention provides, in one embodiment, a system 10 for use in a method for converting a carbonaceous material into an adsorption material. Although the discussion hereinafter references used tires, it should be appreciated that any carbonaceous material, whether used or new automobile tires, or any other similar starting materials or carbon source may also be used. In accordance with one embodiment, used tires may initially be fed into a shredder 11 or other similar mechanical disintegration devices, in order to disintegrate or shred the tires into, for instance, crumb, rubber shreds, rubber pieces, rubber with metallic and/or fiber pieces, and non-rubber pieces. Turning the starting material into shredded pieces can permit the conversion process to be implemented in an easier manner, in comparison to using, for instance a whole tire as a starting material. These shredded or mechanically disintegrated pieces of used tires may vary in size and shape.

The shredded pieces may then be loaded into an insulated heating chamber or reactor 12. The reactor 12, in an embodiment, may be designed to include a sealed chamber, so as to provide a controlled environment or atmosphere therein. The controlled atmosphere within the reactor 13 can be maintained, in an embodiment, at atmospheric pressure at a temperature of about 25° C. when starting materials are introduced.

After loading the shredded pieces into the reactor 12, the shredded pieces may be heated to certain predetermined temperature ranges. The heating of the shredded pieces may be done, in one embodiment, over multiple heating stages during the conversion of a carbonaceous starting material into an adsorption material.

During the first or initial stage of heating, the temperature within the reactor 12 may be raised from about 25° C. to about 100° C. to remove moisture from the shredded pieces. In addition, raising the temperature to about 100° C. can allow the shredded pieces to be carbonized. In one embodiment, the carbonization process may be carried out over a period of approximately an hour.

Next, during the second stage of heating, the temperature within the reactor 12 may be raised to a range of from about 101° C. to about 200° C. At this temperature range, to the extent that there may be non-rubber pieces (i.e., metallic pieces) in the starting material, these pieces can be separated since they may have a relatively higher melting temperature than the rubber pieces. These non-rubber pieces may thereafter be removed from the reactor 12. Removal can be by any means known in the art, for instance, by gravity, by magnetic separation, or other known separation mechanisms.

Subsequent to the removal of the non-rubber pieces, during the third stage of heating, the temperature within the reactor 12 may be raised to a temperature range of from about 201° C. to about 280° C. Once within this temperature range, the shredded pieces may go through an exothermic reaction (i.e., auto-carbonization), leading to an automatic increase in temperature of the shredded pieces, as well as that within the reactor 12 from about 280° C. to about 450° C.

As a result of the exothermic reaction, hydrocarbon gases may be produced, and may continue to be produced until the reactor temperature is approximately 300° C. These hydrocarbon gases, in one embodiment, may contain combustible and non-combustible product, as well as condensable and non-condensable liquids and gases in different proportion within the reactor. The non-condensable gases, in an embodiment, can include approximately 25-35% carbon dioxide, approximately 10-15% carbon monoxide, and approximately 5-10% methane, with the remaining portion containing a mixture of hydrogen, oxygen, and other organic materials, including volatile acids. The average molecular weight of the non-condensable gases generated may be approximately 25.15 kgs/kg mole. In addition, the volume of the non-condensable gas may be about 418.61 m³. It should be noted that hydrocarbons and organic constituents contained within the gas can be used for activation of the porous char or re-circulated at a later time.

With respect to the condensable gases, the average condensable gases may include approximately 92% water, approximately 4% methanol, and approximately 4% organic acids, i.e. acetic acid. The average molecular weight of the condensable gases, on the other hand, may be approximately 20.24 kgs/kg mole. In addition, the density of the condensable gases may be 0.99368 kg/liter.

In accordance with one embodiment of the present invention, the generated hydrocarbon gases may be directed out of the reactor 12 and temporarily stored for later use. To that end, a condenser 13 may be provided to permit separation of water from the hydrocarbon gases (e.g., methanol and acetic acid) prior to their temporary storage. In accordance with one embodiment, the condenser 13 may include a shell (i.e., a large tube) with a series of small tubes situated inside. Other variations on the shell design may be provided, so long as it can lead to temporary storage of the hydrocarbon gases. The stored hydrocarbon gases can, at a later time, be re-circulated back into the reactor 12 to facilitate various processes, as will be discussed hereinafter.

In addition to hydrocarbon gases, the exothermic reaction can generate a substantially solid porous char mass from the shredded pieces present within the reactor 12. The porous char, in an embodiment, may contain different high percentages of fixed carbon content. In one embodiment, the porous char may contain over 80% fixed carbon content. At this stage, the resulting porous char may contain macro-pores and may be moderately dense in nature. Additionally, the porous char may contain nanoscaled size platelets there throughout. In one embodiment, these platelets may be about 0.3 nanometer (nm) thick and a few nanometers in length and width. It should be noted that, on average, approximately 20 pounds of starting material, e.g., used tires, may yield about 4 pounds of porous char having a fixed carbon content of at least 80%. To subsequently obtain a nanostructured adsorption material, this moderately dense porous char must be transformed to a relatively high-density material with a relatively high fixed carbon content.

In order to generate a relatively high fixed carbon content in the porous char, impurities present in the starting materials, and in the transformed material, i.e., porous char, must be removed, so that produce a fixed carbon content in the porous char of greater than about 90% to about 95%. Accordingly, after the exothermic reaction, the heating process may move into a fourth stage.

During this fourth stage, hydrocarbon gases along with a mixture of air and steam may be re-circulated back into the reactor 12 to increase the temperature the chamber. In one embodiment, the temperature within the reactor 12, and thus the temperature of the porous char, may be raised to from about 451° C. to about 1100° C. upon introduction of the hydrocarbon gases and mixture of air and steam. It should be appreciated that for approximately 1 pound of porous char, from about 1 pound to about 1.5 pounds of steam and air mixture may be injected into the reactor. In addition, the amount of steam and air may vary depending upon how dense a volume of pores is to be imparted to the porous char, and could vary from about 0.5 pounds to over 2.0 pounds per pound of porous char.

In accordance with one embodiment, the mixture of steam and air in combination with re-circulated hydrocarbon gases may be used as activating agents to generate additional pores within the porous char. Specifically, the hydrocarbon gases along with air and steam, during this fourth stage of heating, may directed (i.e., injected) onto the surface of the porous char at a temperature of between 1000° C. to about 1100° C. Upon contact with the porous char, the nanoscaled size platelets in the porous char may be caused to become gaseous and evaporate from the porous char, leaving a nanoscaled size space (i.e., pore) behind. The form that the porous char may take, in an embodiment, may be dependent on the uniformity of the structure of the porous char, as well as the fixed carbon content of the porous char prior to this fourth stage. Continued heating and injection of the hydrocarbon gases along with a mixture of steam and air can causes more platelets to evaporate and eventually lead to a porous char with substantially nanoscaled size pores. Furthermore, continuing this physico-chemical activation process can generate a substantially uniform large surface area on the porous char with nanoscaled size pores. In one embodiment, the temperature within the reactor 12 may be maintained at approximately 1000° C. to about 1100° C. by continuing to re-circulate the gaseous products (e.g., hydrocarbons, steam and air) there into.

It should be noted that the introduction of steam and air into the reactor 12, in an embodiment, can generate a producer gas in the presence of hot porous char. The content of the producer gas may vary, but can contain about 15-20% hydrogen, 20-25% carbon monoxide, with the remainder a mixture of nitrogen, hydrocarbons and other organic materials.

Moreover, the re-circulation of the gaseous products during this fourth stage, and if desired, the gaseous by-products from the low temperature carbonization process (i.e., stage one), may make the process of the present invention an energy positive process. To the extent desired, the process of the present invention may be designed to permit only a portion or all of the hydrocarbon gases or particles to be re-circulated back into the reactor 12 for use as a source of energy during the heating process. The presence of the hydrocarbon gases may be uses as a source of energy for generating steam being injected into the reactor 12.

Furthermore, in an embodiment of the present invention, non-condensable gases may be permitted to exit from the reactor 12 and passes through a stack 14 that, in one embodiment, contains adsorption material capable of removing hydrocarbons, SOx NOx, and organic acids.

By heating the porous char in the manner described above, the porous char may be transformed into a relatively high density nanostructured adsorption material with the desired porosity. Typically, approximately 1 pound of the adsorption material can be generated from the 4 pounds of the porous char. The exposure of the porous char to such high temperature, in addition to enlarging and generating pores of various sizes, can provide the resulting adsorption material with internal surface areas ranging from at least approximately 1000 m²/g to approximately 3000 m²/g and higher. In one embodiment, the pore size within the adsorption material can include that on the nanoscale, microscale, mesoscale, and/or macroscale.

Once the conversion of the porous char into a high-density nanoporous adsorption material has taken place, the adsorption material may be retrieved from the reactor 12. This high-density adsorption material, in one embodiment, contains substantially nanoscaled size pores, but may also include pores having a size at the microscale, mesoscale and/or macroscale level. It should be noted that the process of the present invention can also impart special properties to the nanoporous adsorption material. In particular, such a process can impart the adsorption material with properties necessary for removal of particulates and contaminants from gaseous, as well as liquid flow.

It should be appreciated that the reactor 12 may be designed to accommodate the four heating stages within one chamber. Alternatively, multiple chambers may be used. To the extent that multiple chambers may be used, reactor 12 may be provided, in an embodiment, distinct chambers with each capable of accommodating one stage of heating. For such a design, a transport mechanism, such as a conveyor belt or any other mechanisms known in the art, may be use to move the materials from one chamber to another.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains.

What is claimed is:

1. A process for generating an adsorption material, the process comprising:
providing, in a controlled atmosphere, a carbonaceous source;
heating the source to a temperature sufficient to achieve an exothermic reaction, so as to generate (a) hydrocarbon gases, and (b) a substantially solid porous char mass having a relatively high carbon content;
re-circulating, into the controlled atmosphere, the hydrocarbon gases along with a mixture of steam and air to substantially increase the temperature therein;
in the presence of increased temperature, allowing the porous char mass to be converted into a porous adsorption material.

2. A process as set forth in claim 1, wherein in the step of providing, the controlled atmosphere is maintained at atmospheric pressure.

3. A process as set forth in claim 1, wherein the step of heating includes heating the source to a temperature ranging from about 201° C. to about 280° C.

4. A process as set forth in claim 1, wherein the step of heating, during the exothermic reaction the temperature within the controlled atmosphere is from about 281° C. to about 450° C.

5. A process as set forth in claim 1, wherein in the step of heating, the hydrocarbon gases include condensable and non-condensable products.

6. A process as set forth in claim 5, wherein the step of heating, the condensable and non-condensable products exist in different proportions.

7. A process as set forth in claim 5, wherein the step of heating includes utilizing the condensable products as a source of energy during the exothermic reaction.

8. A process as set forth in claim 5, wherein the step of heating includes permitting the non-condensable products to exit from the controlled atmosphere.

9. A process as set forth in claim 1, wherein in the step of heating, the porous char mass has a carbon content of at least 80 percent.

10. A process as set forth in claim 1, wherein in the step of heating, the porous char mass includes nanoscaled size platelets capable of subsequently being evaporated to produce nanoscaled size pores.

11. A process as set forth in claim 1, wherein the step of re-circulating, the temperature of the controlled atmosphere ranges from about 451° C. to about 1100° C.

12. A process as set forth in claim 1, wherein the step of re-circulating includes maintaining the temperature within the controlled atmosphere from about 1000° C. to about 1100° C.

13. A process as set forth in claim 1, wherein the step of re-circulating includes generating nanoscaled size pores from nanoscaled size plates within the porous char mass.

14. A process as set forth in claim 13, wherein the step of generating includes utilizing the hydrocarbon gases as an activating agent to generate additional nanoscaled size pores within the porous char mass.

15. A process as set forth in claim 1, wherein in the step of allowing, the conversion of the porous char mass into a porous adsorption material involves a physico-chemical activation process.

16. A process as set forth in claim 1, wherein in the step of allowing, the porous adsorption material includes substantially pores that are nanoscale in size.

17. A process as set forth in claim 16, wherein in the step of allowing, the porous adsorption material also includes pores that are microscale, mesoscale, or macroscale in size or a combination thereof.

18. A process for generating an adsorption material, the process comprising:
providing, in a controlled atmosphere, a carbonaceous source;
heating the source to a temperature sufficient to achieve an exothermic reaction, so as to generate a substantially solid porous char mass having a relatively high carbon content and a plurality of nanoscaled size platelets dispersed throughout the porous char mass;
injecting hydrocarbon gases and a mixture of steam and air into the controlled atmosphere to substantially increase the temperature therein;
in the presence of increased temperature, allowing the platelets on the porous char to evaporate, so as to generate nanoscaled size pores; and
continuing exposure of the porous char to the increased temperature to permit the porous char mass to be converted into a porous adsorption material.

19. A process as set forth in claim 16, wherein in the step of heating, the hydrocarbon gases include condensable and non-condensable products.

20. A process as set forth in claim 18, wherein the step of heating includes utilizing the condensable products as a source of energy during the exothermic reaction.

21. A process as set forth in claim 16, wherein the step of heating, the porous char mass has a carbon content of at least 80 percent.

22. A process as set forth in claim 16, wherein in the step of allowing, the porous adsorption material also includes pores that are microscale, mesoscale, or macroscale in size or a combination thereof.
